(19) United States
(12) Patent Application Publication
(10) Pub. No.: US 2025/0384719 A1
(43) Pub. Date: Dec. 18, 2025

(54) METHOD AND DEVICE FOR ESTIMATING MASS

(71) Applicant: HL MANDO CORPORATION, Pyeongtaek-si (KR)

(72) Inventor: Gyuwon KIM, Pyeongtaek-si (KR)

(73) Assignee: HL MANDO CORPORATION, Pyeongtaek-si (KR)

(21) Appl. No.: 19/040,187

(22) Filed: Jan. 29, 2025

(30) Foreign Application Priority Data
Jun. 12, 2024 (KR) 10-2024-0076227

(51) Int. Cl. G07C 5/02

(52) U.S. Cl. CPC G07C 5/02

(57) ABSTRACT

The present embodiments relate to a method and a device for estimating mass comprising receiving sensing information generated by one or more sensors, determining whether a preset condition is satisfied based on the sensing information, determining a driving force, by using the sensing information in response to a determination that the preset condition is satisfied, determining one or more identification information, by using a distinction algorithm based on the sensing information and the driving force, and estimating mass of a vehicle, by using a mass estimation algorithm, based on the one or more identification information.

### CROSS REFERENCE TO RELATED APPLICATION

This application claims priority from Korean Patent Application No. 10-2024-0076227, filed on Jun. 12, 2024, which is hereby incorporated by reference for all purposes as if fully set forth herein.

### TECHNICAL FIELD

An embodiment of the present disclosure relates to a method and a device for estimating mass.

### BACKGROUND

The mass of a vehicle may be utilized for various control functions including a braking control and an active suspension control. The mass of a vehicle is a parameter closely related to a behavior of a vehicle.

In general control functions, the mass of a vehicle has been utilized without considering dynamic changes such as fuel consumption, passenger presence, and cargo volume. That is, the control function of the vehicle has been implemented using a static parameter identification technique based on an empty vehicle weight or a curb weight.

However, recently, due to the introduction of autonomous vehicles and electric vehicles, there may be not sufficient a method utilizing the mass of a vehicle or a curb weight only as a static parameter.

Therefore, it is required a method capable of real-time mass estimation, but the technology therefor is still insufficient.

### SUMMARY

Embodiments of the present disclosure may provide a method and a device for estimating mass.

In accordance with an aspect of the present disclosure, there may be provided a method for estimating mass, the method comprising receiving sensing information generated by one or more sensors, determining whether a preset condition is satisfied based on the sensing information, determining a driving force, by using the sensing information, in response to a determination that the preset condition is satisfied, determining one or more identification information, by using a distinction algorithm based on the sensing information and the driving force, and estimating mass of a vehicle, by using a mass estimation algorithm based on the one or more identification information.

In accordance with another aspect of the present disclosure, there may be provided a device for estimating mass, the device comprising a receiver configured to receive sensing information generated by one or more sensors, a condition determiner configured to determine whether a preset condition is satisfied based on the sensing information, a driving force determiner configured to determine a driving force, by using the sensing information, in response to a determination that the preset condition is satisfied, an identification information determiner configured to determine one or more identification information, by using a distinction algorithm, based on the sensing information and the driving force, and an estimator configured to estimate mass of a vehicle, by using a mass estimation algorithm, based on the one or more identification information.

In accordance with another aspect of the present disclosure, there may be provided a vehicle control device including at least one memory configured to store computer program instructions, and at least one processor configured to execute the computer program instructions, wherein the at least one processor is configured to: determine whether a preset condition is satisfied based on sensing information generated by one or more sensors, determine, in response to a determination that the preset condition is satisfied, one or more identification information, by using a distinction algorithm, based on the sensing information and a driving force determined using the sensing information, and estimate mass of a vehicle, by using a mass estimation algorithm, based on the one or more identification information.

According to an embodiment of the present disclosure, it is possible to provide a method and a device for estimating mass.

### BRIEF DESCRIPTION OF THE DRAWINGS

FIG. 1 is a flow chart for explaining a method for estimating mass according to an embodiment.

FIG. 2 is a flow chart for explaining the operations of a distinction algorithm according to an embodiment.

FIG. 3 is a flow chart for explaining a mass estimation operation of a mass estimation algorithm according to an embodiment.

FIG. 4 is a diagram for explaining an actual mass and an estimated mass using a mass estimation algorithm according to an embodiment.

FIG. 5 is a diagram for explaining a device for estimating mass according to an embodiment.

FIG. 6 is a block diagram of an exemplary computing system.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements. When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

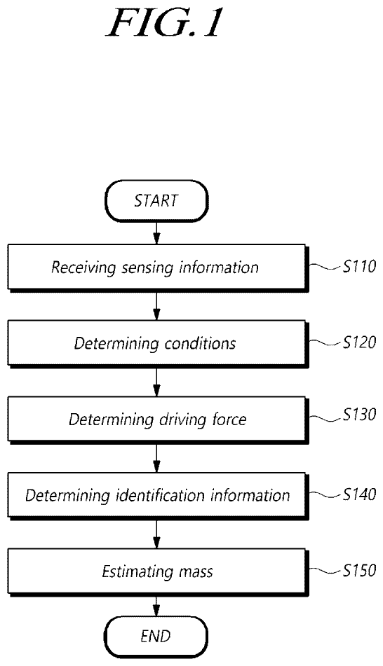

FIG. 1 is a flow chart for explaining a method for estimating mass according to an embodiment.

Referring to FIG. 1, a method for estimating mass may comprise a sensing information receiving step (S110) of receiving sensing information generated by one or more sensors, a condition determination step (S120) of determining whether a preset condition is satisfied based on the sensing information, a driving force determination step (S130) of determining a driving force, by using the sensing information in response to a determination that the preset condition is satisfied, an identification information determination step (S140) of determining one or more identification information, by using a distinction algorithm, based on the sensing information and the driving force, and an estimation step (S150) of estimating mass of a vehicle, by using a mass estimation algorithm, based on the one or more identification information.

The sensing information receiving step may include receiving sensing information generated by one or more sensors. (S110)

For example, the one or more sensors may include a brake sensor capable of generating brake information, a speed sensor capable of generating vehicle speed information, an acceleration sensor capable of generating vehicle acceleration information, a gyroscope capable of generating gradient information, a wheel speed sensor capable of generating wheel speed information, and a wheel torque sensor capable of generating wheel torque information. However, the present disclosure is not limited to the sensors described above, and various sensors may be included.

For another example, the sensing information may include at least one of brake information, speed information, acceleration information, gradient information, wheel speed information, and wheel torque information.

For example, the brake information may include brake pressure information, brake temperature information, and brake operating time information. For another example, the speed information may refer to a speed of a vehicle generated when the vehicle is driving on a road. For another example, the acceleration information may refer to the acceleration of the vehicle generated when the vehicle is driving on a road. As another example, gradient information may mean a slope of a road or a degree of inclination of the road when the vehicle is driving on the road. As another example, wheel speed information may mean the rotation speed of the front or rear wheels of the vehicle. As another example, wheel torque information may mean the torque generated by the rotation of the front or rear wheels of the vehicle.

In addition, the sensing information may be received from one or more sensors through a Controller Area Network (CAN) communication. In addition, the sensing information may be transmitted to various control devices (e.g., engine, airbag, brake, ECU, etc.) of the vehicle through CAN communication.

In the condition determination step, there may be determined whether a preset condition is satisfied based on the sensing information. (S120)

For example, the preset condition may include a first condition, which is set to determine a magnitude of a braking force based on the brake information, a second condition, which is set to determine whether the vehicle is slipping based on the wheel speed information, and a third condition, which is set to determine the slope of the road based on the gradient information.

As an example, the first condition may be set to determine the magnitude or a level of the braking force based on the brake information. The first condition may be set to determine whether the magnitude of the braking force determined based on the brake pressure information included in the brake information corresponds to 0. In the condition determination step, the first condition may be determined to be satisfied if the magnitude of the braking force is 0. However, the present embodiment is not limited thereto, and the magnitude of the braking force may be determined in various ways.

As another example, the second condition may be set to determine whether the vehicle is slipping based on the wheel speed information. The second condition may be set to whether or not a difference in the wheel speeds of each vehicle included in the wheel speed information occurs by comparing the wheel speeds of each vehicle. In the condition determination step, the second condition may be determined to be satisfied if no difference in wheel speed occurs. However, the present embodiment is not limited thereto, and whether the vehicle is slipping may be determined in various ways.

As another example, the third condition may be set to determine the slope of the road based on gradient information. The gradient information may be received through a gyroscope mounted on the vehicle. The third condition may be set to whether or not the slope of the road corresponds to 0. In the condition determination step, there may be determined that the third condition is satisfied if the slope of the road corresponds to 0. However, the present embodiment is not limited thereto, and the slope of the road may be determined in various ways.

In addition, the preset condition may include various conditions and may be set using various sensing information.

For another example, in the condition determination step, if at least one of the first condition, the second condition, and the third condition is satisfied, there may be determined that the preset condition is satisfied.

For another example, in the condition determination step, there may be determined that the preset condition is satisfied if one of the first condition, the second condition, and the third condition is satisfied. For another example, the condition determination step may include a step of determining that the preset condition is satisfied if two or more of the first condition, the second condition, and the third condition are satisfied.

In the driving force determination step, if it is determined that a preset condition is satisfied, the driving force may be determined using the sensing information. (S130)

For example, the driving force may be determined the driving force, based on the wheel torque information included in the sensing information, reduction ratio information of the vehicle, mechanical efficiency information, and turning radius information.

For example, referring to the Equation 1, the driving force Fx may be determined using the wheel torque information Tm, the reduction ratio information G of the vehicle, the mechanical efficiency information (η), and the turning radius information R.

$${F}_{x} = \frac{{T}_{m} G η}{R} \qquad [ Equation 1 ]$$

Referring to the Equation 1, Fx may represent the driving force. Tm may represent wheel torque information or a drive motor output torque. G may represent reduction gear ratio information or reduction gear ratio. A reducer may reduce the rotational speed of a motor and amplify torque at the same time by using a gear. Here, the reduction ratio information G may represent a ratio at which the reducer reduces the rotational speed of the motor. η may represent mechanical efficiency information or a mechanical efficiency. R may represent turning radius information or an effective rolling radius of wheel. That is, R may represent radius information of a wheel of a vehicle.

In addition, G, η and R may correspond to vehicle-specific characteristics, and G, η and R may be set differently depending on the vehicle. However, the determination of the driving force may be not limited to this embodiment and may be determined in various ways. For convenience of explanation, the definitions of Fx, G, η and R will be described later.

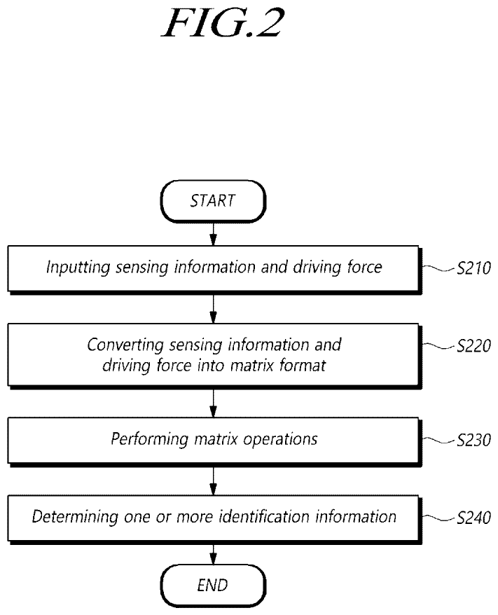

In the identification information determination step, one or more identification information may be determined using the distinction algorithm, based on the sensing information and the driving force. (S140) The identification information determination step is described in more detail below with reference to FIG. 2.

FIG. 2 is a flowchart for explaining the operations of the distinction algorithm according to one embodiment. Referring to FIG. 2, the distinction algorithm may determine one or more identification information by converting the speed information and acceleration information and the driving force included in the sensing information into a matrix format and using one or more matrix operations.

For example, the distinction algorithm may perform an operation based on the sensing information and the driving force as input values. (S210)

For another example, the distinction algorithm may perform an operation of converting sensing information and driving force into a matrix format. (S220)

The distinction algorithm may convert speed information v, acceleration information ú and driving force Fx into a matrix format. Referring to an Equation 2, the driving force Fx may be converted into a matrix of yₖ. Referring to an Equation 3, the speed information v and acceleration information ú may be converted into a matrix of hₖ^{τ}.

$${y}_{k} = {F}_{x} \qquad [ Equation 2 ]$$

$${h}_{k}^{T} = [ \begin{matrix}\dot{v} & {v}^{2} & 1\end{matrix} ] \qquad [ Equation 3 ]$$

For another example, the distinction algorithm may perform an operation utilizing one or more matrix operations. (S230) For another example, the distinction algorithm may perform an operation determining one or more identification information. (S240)

In this case, the distinction algorithm may determine one or more identification information θₖ utilizing one or more matrix operations such as Equation 4.

$${y}_{k} = {h}_{k}^{T} {θ}_{k} + {v}_{k} \qquad [ Equation 4 ]$$

Referring to Equation 5, θₖ may mean one or more identification information. The one or more identification information θₖ may include rolling friction force information \hat{F}_{rolling}, aerodynamic drag coefficient information Ĉ_{df}, and mass estimation information \hat{m}. In addition, the one or more identification information θₖ may include rolling friction force information \hat{F}_{rolling}, aerodynamic drag coefficient information Ĉ_{df}, and mass estimation information \hat{m} in matrix format. In addition, vₖ may mean a set of constants in matrix format.

$${θ}_{k} = {[ \begin{matrix}\hat{m} & {\hat{C}}_{df} & {\hat{F}}_{rolling}\end{matrix} ]}^{T} \qquad [ Equation 5 ]$$

In this case, the rolling friction information \hat{F}_{rolling} may mean a frictional force generated when the wheel of the vehicle rolls and the wheel is crushed and restored to its original state at the contact surface at every moment.

In addition, the aerodynamic drag coefficient information Ĉ_{df} may mean a coefficient related to a resistance force received by the vehicle when driving in the air or fluid.

In addition, the mass estimation information \hat{m} may mean an estimated value of the mass of the vehicle as a value which may be used as an input value for the mass estimation algorithm.

Referring to Equation 6, one or more identification information, such as rolling friction force information \hat{F}_{rolling}, aerodynamic drag coefficient information Ĉ_{df}, and mass estimation information \hat{m}, determined using a distinction algorithm may be substituted into the Equation 6, and may be used to estimate mass in the estimation step later.

$$m \dot{v} = {F}_{x} - {F}_{drag} - {F}_{rolling} = {F}_{x} - \frac{1}{2} ρ {C}_{df} {A}_{f} {v}^{2} - {C}_{rr} mg \qquad [ Equation 6 ]$$

In the Equation 6, m may mean the mass of the vehicle, and Fdrag may correspond to

$$\frac{1}{2} ρ {C}_{df} {A}_{f} {v}^{2} .$$

Here, ρ may mean the density of air or fluid.

Af may mean the frontal area of the vehicle. Crr may mean the rolling resistance coefficient.

The operation of determining one or more identification information of the distinction algorithm may be performed in the same manner using a Recursive Least Square Estimator (RLSE). However, the operation of the distinction algorithm is not limited to the present embodiment, and may include various operations, and various algorithms capable of determining one or more identification information may be used.

In the estimation step, the mass of the vehicle may be estimated using a mass estimation algorithm based on one or more identification information. (S150)

For example, the mass estimation algorithm may correspond to one of an Adaptive Extended Kalman Filter (AEKF) and a Kalman Filter (KF).

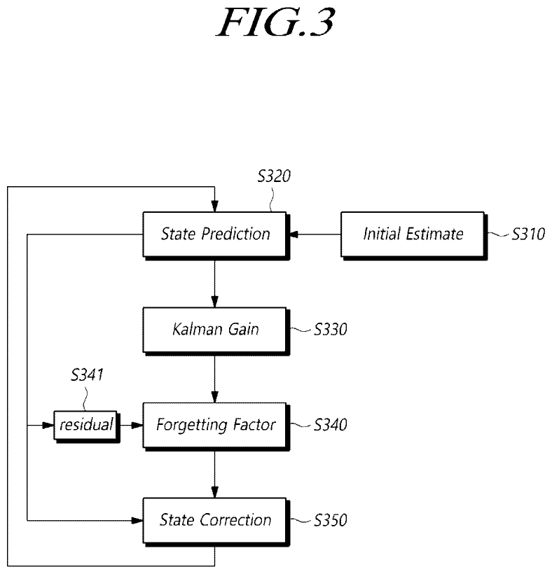

However, the mass estimation algorithm is not limited to the present embodiment, and may be any algorithm capable of estimating mass in various ways. It will be described a detailed description of the mass estimation algorithm with reference to FIG. 3.

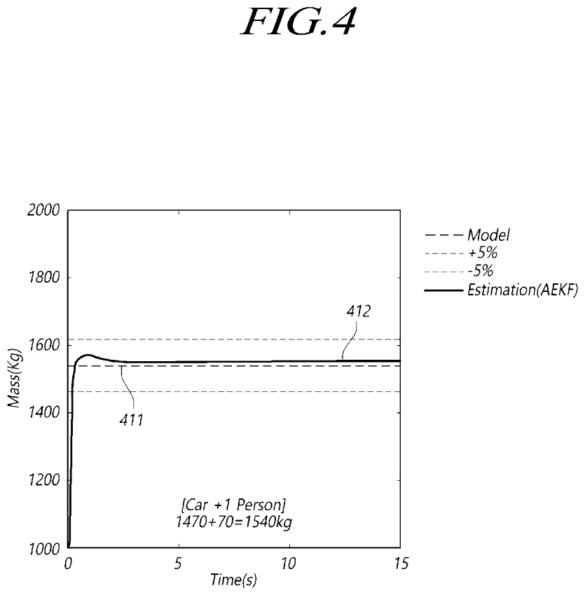

FIG. 3 is a flow chart for explaining a mass estimation operation of a mass estimation algorithm according to an embodiment. FIG. 4 is a diagram for explaining an actual mass and an estimated mass using a mass estimation algorithm according to an embodiment.

Referring to FIG. 3, the mass estimation algorithm may correspond to an Adaptive Extended Kalman Filter (AEKF), and the AEKF may include five operations.

The Initial Estimate operation (S310) may mean an operation for determining one or more identification information, which is an output value in the identification information determination step. By using S310, one or more identification information may be determined and used in the mass estimation algorithm together with sensing information.

The State Prediction operation (S320) may include receiving one or more identification information and sensing information determined through S310 as input values. A current mass estimation state and a predicted mass estimation state may be generated using the input values. The step of S320 may include converting the current mass estimation state into the predicted mass estimation state using AEKF.

The Kalman Gain operation (S330) may be an operation for determining a weight between the estimated value of the predicted mass estimation state and the actual measured value.

The Forgetting Factor Determination operation (S340) may

mean an operation to set a higher weight to the actual measured value so as to gradually reduce the influence of past information over time. In this case, a Residual operation (S341) may be performed together. The step of S341 may mean an operation to determine the difference between the actual measured value and the estimated value of the predicted mass estimation state. The step of S340 may including evaluating the difference between the actual measured value and the estimated value of the predicted mass estimation state determined through S341 to determine the accuracy of the AEKF estimation value and set a manner for setting the weight.

The State Correction operation (S350) may mean an operation to correct the estimated value of the predicted mass estimation state by using the difference between the predicted mass estimation state and the actual measured value. In this case, the weight determined in S330 may be used to adjust the difference between the actual measured value and the estimated value of the predicted mass estimation state, and finally, the estimated value of the predicted mass estimation state may be updated.

In addition, the mass estimation algorithm may perform the S320 to S350 operations multiple times to accurately estimate the mass of the vehicle. Referring to FIG. 4, there is illustrated that the mass estimation algorithm performs the S320 to S350 operations multiple times to derive an accurate mass estimation result.

The graph 410 may include of a horizontal axis indicating the number of repetitions of the mass estimation algorithm and a vertical axis indicating the mass. The dotted line 411 may indicate a weight of the vehicle. For example, the weight of the vehicle may correspond to 1,540 kg, which is the combined weight of the vehicle itself and one person. The solid line 412 may indicate the mass of the vehicle estimated through the mass estimation algorithm.

For example, if the mass estimation algorithm is repeated once or twice, the solid line 412 may exceed the dotted line 411. Meanwhile, if the mass estimation algorithm is repeated about 5 times or more, the solid line 412 may be stabilized parallel to the dotted line 411.

That is, in the estimation step, the exact mass of the vehicle may be estimated by repeatedly performing the mass estimation algorithm.

Therefore, the estimation step may further include a step of repeating the mass estimation algorithm two or more times.

This embodiment has been described mainly with respect to the AEKF, but the KF (Kalman Filter) may also perform an operation of estimating the mass of the vehicle by combining the State Prediction operation (S320), the Kalman Gain operation (S330), and the State Correction operation (S350) like the AEKF.

In addition, this embodiment has been described mainly with respect to the AEKF and the KF, but if there is a filter or algorithm capable of estimating the mass of the vehicle, there may be used without limitation.

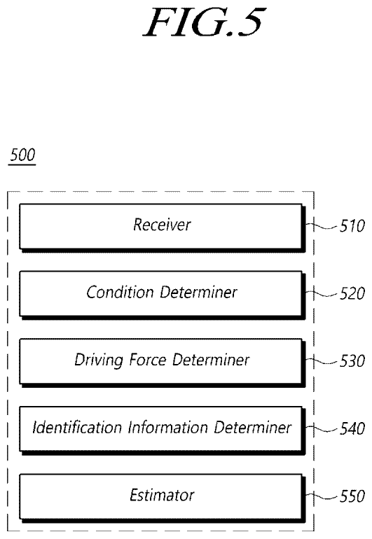

FIG. 5 is a diagram for explaining a device for estimating mass according to an embodiment.

Referring to FIG. 5, a device for estimating mass may comprise a receiver 510 for receiving sensing information generated by one or more sensors, a condition determiner 520 for determining whether a preset condition is satisfied based on the sensing information, a driving force determiner 530 for determining a driving force, by using the sensing information, in response to a determination that the preset condition is satisfied, an identification information determiner 540 for determining one or more identification information, by using a distinction algorithm, based on the sensing information and the driving force, and an estimator 550 for estimating mass of a vehicle, by using a mass estimation algorithm, based on the one or more identification information.

The receiver 510 may receive sensing information generated by one or more sensors.

For example, the one or more sensors may include a brake sensor capable of generating brake information, a speed sensor capable of generating vehicle speed information, an acceleration sensor capable of generating vehicle acceleration information, a gyroscope capable of generating gradient information, a wheel speed sensor capable of generating wheel speed information, and a wheel torque sensor capable of generating wheel torque information. However, the present disclosure is not limited to the sensors described above, and various sensors may be included.

For another example, the sensing information may include at least one of brake information, speed information, acceleration information, gradient information, wheel speed information, and wheel torque information.

For example, the brake information may include brake pressure information, brake temperature information, and brake operating time information. For another example, the speed information may refer to a speed of a vehicle generated when the vehicle is driving on a road. For another example, the acceleration information may refer to the acceleration of the vehicle generated when the vehicle is driving on a road. As another example, gradient information may mean a slope of a road or a degree of inclination of the road when the vehicle is driving on the road. As another example, wheel speed information may mean the rotation speed of the front or rear wheels of the vehicle. As another example, wheel torque information may mean the torque generated by the rotation of the front or rear wheels of the vehicle.

In addition, the sensing information may be received from one or more sensors through a Controller Area Network (CAN) communication. In addition, the sensing information may be transmitted to various control devices (e.g., engine, airbag, brake, ECU, etc.) of the vehicle through CAN communication.

The condition determiner 520 may determine whether a preset condition is satisfied based on the sensing information.

For example, the preset condition may include a first condition, which is set to determine a magnitude of the braking force based on the brake information, a second condition, which is set to determine whether the vehicle is slipping based on the wheel speed information, and a third condition, which is set to determine the slope of the road based on the gradient information.

As an example, the first condition may be set to determine the magnitude or a level of the braking force based on the brake information. The first condition may be set to determine whether the magnitude of the braking force determined based on the brake pressure information included in the brake information corresponds to 0. The condition determiner 520 may determine that the first condition is satisfied if the magnitude of the braking force is 0. However, the present embodiment is not limited thereto, and the magnitude of the braking force may be determined in various ways.

As another example, the second condition may be set to determine whether the vehicle is slipping based on the wheel speed information. The second condition may be set to whether or not a difference in the wheel speeds of each vehicle included in the wheel speed information occurs by comparing the wheel speeds of each vehicle. The condition determiner 520 may determine that the second condition is satisfied if no difference in wheel speed occurs. However, the present embodiment is not limited thereto, and whether the vehicle is slipping may be determined in various ways.

As another example, the third condition may be set to determine the slope of the road based on gradient information. The gradient information may be received through a gyroscope mounted on the vehicle. The third condition may be set to whether or not the slope of the road corresponds to 0. The condition determiner 520 may determine that the third condition is satisfied if the slope of the road corresponds to 0. However, the present embodiment is not limited thereto, and the slope of the road may be determined in various ways.

In addition, the preset condition may include various conditions and may be set using various sensing information.

For another example, the condition determiner 520 may determine that the preset condition is satisfied if at least one of the first condition, the second condition, and the third condition is satisfied.

For another example, the condition determiner 520 may determine that the preset condition is satisfied if one of the first condition, the second condition, and the third condition is satisfied. For another example, the condition determiner 520 may determine that the preset condition is satisfied if two or more of the first condition, the second condition, and the third condition are satisfied.

The driving force determiner 530 may determine, if it is determined that a preset condition is satisfied, the driving force using the sensing information.

For example, the driving force may be determined using the wheel torque information included in the sensing information, reduction ratio information of the vehicle, mechanical efficiency information, and turning radius information.

The identification information determiner 540 may determine one or more identification information using a distinction algorithm based on sensing information and the driving force.

The distinction algorithm may determine one or more identification information by converting the speed information, acceleration information, and driving force included in the sensing information into a matrix format and using one or more matrix operations.

For example, the distinction algorithm may perform an operation using the sensing information and the driving force as input values.

For another example, the distinction algorithm may perform an operation of converting the sensing information and the driving force into a matrix format.

The distinction algorithm may convert speed information v, acceleration information ú and driving force Fx into a matrix format. The driving force Fx may be converted into a matrix of yₖ. The speed information v and acceleration information ú may be converted into a matrix of hₖ^{T}.

As another example, the distinction algorithm may perform an operation which utilizes one or more matrix operations. As another example, the distinction algorithm may perform an operation of determining one or more pieces of identification information.

The one or more identification information θₖ may include rolling friction force information \hat{F}_{rolling}, aerodynamic drag coefficient information Ĉ_{df}, and mass estimation information \hat{m}. In addition, the one or more identification information θₖ may include rolling friction force information \hat{F}_{rolling}, aerodynamic drag coefficient information Ĉ_{df}, and mass estimation information \hat{m} in matrix format. In addition, vₖ may mean a set of constants in matrix format.

In this case, the rolling friction information \hat{F}_{rolling} may mean a frictional force generated when the wheel of the vehicle rolls and the wheel is crushed and restored to its original state at the contact surface at every moment.

In addition, the aerodynamic drag coefficient information Ĉ_{df} may mean a coefficient related to a resistance force received by the vehicle when driving in the air or fluid.

In addition, the mass estimation information \hat{m} may mean an estimated value of the mass of the vehicle as a value which may be used as an input value for the mass estimation algorithm.

The one or more identification information, such as rolling friction force information \hat{F}_{rolling}, aerodynamic drag coefficient information. Ĉ_{df}, and mass estimation information \hat{m}, determined using a distinction algorithm may be used later in the estimator to estimate the mass.

The operation of determining one or more identification information of the distinction algorithm may be performed in the same manner using a Recursive Least Square Estimator (RLSE). However, the operation of the distinction algorithm is not limited to the present embodiment, and may include various operations, and various algorithms capable of determining one or more identification information may be used.

The estimator 550 may estimate the mass of the vehicle using a mass estimation algorithm based on one or more identification information.

For example, the mass estimation algorithm may correspond to one of an Adaptive Extended Kalman Filter (AEKF) and a Kalman Filter (KF).

However, the mass estimation algorithm is not limited to the present embodiment, and may be any algorithm capable of estimating mass in various ways.

In some embodiments, each of the receiver 510, the condition determiner 520, the driving force determiner 530, the identification information determiner 540, and the estimator 550 includes one or more hardware processors.

Meanwhile, the present disclosure may include a vehicle control device for implementing the above-described device and/or method. For example, the vehicle control device may be implemented as a computing system.

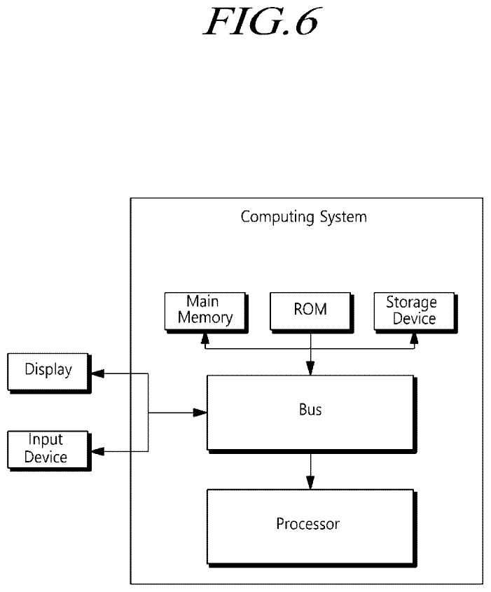

FIG. 6 is a block diagram of an exemplary computing system.

A vehicle control device according to one embodiment may include at least one memory configured to store computer program instructions and at least one processor configured to execute the computer program instructions.

The at least one processor may determine whether a preset condition is satisfied based on sensing information generated by one or more sensors, may determine, in response to a determination that the preset condition is satisfied, one or more identification information, by using a distinction algorithm, based on the sensing information and a driving force determined using the sensing information, and may estimate mass of a vehicle, by using a mass estimation algorithm, based on the one or more identification information.

For example, the sensing information may include at least one of brake information, speed information, acceleration information, gradient information, wheel speed information, and wheel torque information.

In addition, the preset condition may include a first condition set to determine a magnitude of the braking force based on the brake information, a second condition set to determine whether the vehicle is slipping based on the wheel speed information, and a third condition set to determine a slope of a road based on the gradient information. At least one processor may determine that a preset condition is satisfied if any one of the first to third conditions is satisfied.

The distinction algorithm may be an algorithm for converting speed information, acceleration information and the driving force into matrix format, and determining one or more identification information using one or more matrix operations.

In addition, at least one processor may execute operations necessary to perform the mass estimation device and method operations described above.

The computer system or computing device can include or be used to implement the system or its components such as the data processing system. The computing system includes a bus or other communication component for communicating information and a processor or processing circuit coupled to the bus for processing information. The computing system can also include one or more processors or processing circuits coupled to the bus for processing information. The computing system also includes main memory, such as a random access memory (RAM) or other dynamic storage device, coupled to the bus for storing information, and instructions to be executed by the processor. The main memory can be or include the data repository. The main memory can also be used for storing position information, temporary variables, or other intermediate information during execution of instructions by the processor. The computing system may further include a read-only memory (ROM) or other static storage device coupled to the bus for storing static information and instructions for the processor. A storage device, such as a solid state device, magnetic disk or optical disk, can be coupled to the bus to persistently store information and instructions. The storage device can include or be part of the data repository.

The computing system may be coupled via the bus to a display, such as a liquid crystal display or active matrix display, for displaying information to a user. An input device, such as a keyboard including alphanumeric and other keys, may be coupled to the bus for communicating information and command selections to the processor. The input device can include a touch screen display. The input device can also include a cursor control, such as a mouse, a trackball, or cursor direction keys, for communicating direction information and command selections to the processor and for controlling cursor movement on the display. The display can be part of the data processing system, the client computing device or other component.

The processes, systems and methods described herein can be implemented by the computing system in response to the processor executing an arrangement of instructions contained in main memory. Such instructions can be read into main memory from another computer-readable medium, such as the storage device. Execution of the arrangement of instructions contained in main memory causes the computing system to perform the illustrative processes described herein. One or more processors in a multiprocessing arrangement may also be employed to execute the instructions contained in main memory. Hard-wired circuitry can be used in place of or in combination with software instructions together with the systems and methods described herein. Systems and methods described herein are not limited to any specific combination of hardware circuitry and software.

Although an example computing system has been described, the subject matter including the operations described in this specification can be implemented in other types of digital electronic circuitry, or in computer software, firmware, or hardware, including the structures disclosed in this specification and their structural equivalents, or in combinations of one or more of them.

The terms “data processing system,” “computing device,” “component,” or “data processing apparatus” encompass various apparatuses, devices, and machines for processing data, including by way of example a programmable processor, a computer, a system on a chip, or multiple ones, or combinations of the foregoing. The apparatus can include special-purpose logic circuitry, e.g., an FPGA (field-programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The components of system can include or share one or more data processing apparatuses, systems, computing devices, or processors

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system) to perform actions by operating on input data and generating output. The processes and logic flows can also be performed by, and apparatuses can also be implemented as, special purpose logic circuitry, e.g., an FPGA (field-programmable gate array) or an ASIC (application-specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A method for estimating mass, the method comprising:
receiving sensing information generated by one or more sensors;
determining whether a preset condition is satisfied based on the sensing information;
determining a driving force, by using the sensing information, in response to a determination that the preset condition is satisfied;
determining one or more identification information, by using a distinction algorithm based on the sensing information and the driving force; and
estimating mass of a vehicle, by using a mass estimation algorithm, based on the one or more identification information.

2. The method of claim 1, wherein the sensing information includes at least one of brake information, speed information, acceleration information, gradient information, wheel speed information, and wheel torque information.

3. The method of claim 2, wherein the preset condition includes a first condition, which is set to determine a magnitude of a braking force based on the brake information, a second condition, which is set to determine whether the vehicle is slipping based on the wheel speed information, and a third condition, which is set to determine a slope of a road based on the gradient information.

4. The method of claim 3, wherein the determining whether the preset condition is satisfied comprises:
determining that the preset condition is satisfied when at least one of the first condition, the second condition, and the third condition is satisfied.

5. The method of claim 1, wherein the determining the driving force comprises:
determining the driving force, based on wheel torque information included in the sensing information, reduction ratio information of the vehicle, mechanical efficiency information, and turning radius information.

6. The method of claim 1, wherein the distinction algorithm is an algorithm that converts speed information, acceleration information, and the driving force, into matrix format, and determines the one or more identification information, by using one or more matrix operations.

7. The method of claim 6, wherein the one or more of identification force information includes rolling friction information, aerodynamic drag coefficient information, and mass estimation information.

8. The method of claim 1, wherein the mass estimation algorithm corresponds to one of an Adaptive Extended Kalman Filter (AEAF) or a Kalman Filter (KF).

9. A device for estimating mass, the device comprising:
a receiver configured to receive sensing information generated by one or more sensors;
a condition determiner configured to determine whether a preset condition is satisfied based on the sensing information;
a driving force determiner configured to determine a driving force, by using the sensing information, in response to a determination that the preset condition is satisfied;
an identification information determiner configured to determine one or more identification information, by using a distinction algorithm, based on the sensing information and the driving force; and
an estimator configured to estimate mass of a vehicle, by using a mass estimation algorithm, based on the one or more identification information.

10. The device of claim 9, wherein the sensing information includes at least one of brake information, speed information, acceleration information, gradient information, wheel speed information, and wheel torque information.

11. The device of claim 10, wherein the preset condition includes a first condition, which is set to determine a magnitude of a braking force based on the brake information, a second condition, which is set to determine whether the vehicle is slipping based on the wheel speed information, and a third condition, which is set to determine a slope of a road based on the gradient information.

12. The device of claim 11, wherein the condition determiner is further configured to determine that the preset condition is satisfied when at least one of the first condition, the second condition, and the third condition is satisfied.

13. The device of claim 9, wherein the driving force determiner is further configured to determine the driving force, based on wheel torque information included in the sensing information, reduction ratio information of the vehicle, mechanical efficiency information, and turning radius information.

14. The device of claim 9, wherein the distinction algorithm is an algorithm that converts speed information, acceleration information and the driving force into matrix format, and determines the one or more identification information, by using one or more matrix operations.

15. The device of claim 14, wherein the one or more of identification information includes rolling friction force information, aerodynamic drag coefficient information, and mass estimation information.

16. The device of claim 9, wherein the mass estimation algorithm corresponds to one of an Adaptive Extended Kalman Filter (AEAF) or a Kalman Filter (KF).

17. A vehicle control device comprising:
at least one memory configured to store computer program instructions; and
at least one processor configured to execute the computer program instructions,
wherein the at least one processor is configured to:
determine whether a preset condition is satisfied based on sensing information generated by one or more sensors;
determine, in response to a determination that the preset condition is satisfied, one or more identification information, by using a distinction algorithm, based on the sensing information and a driving force determined using the sensing information; and
estimate mass of a vehicle, by using a mass estimation algorithm, based on the one or more identification information.

18. The vehicle control device of claim 17, wherein the sensing information includes at least one of brake information, speed information, acceleration information, gradient information, wheel speed information, and wheel torque information.

19. The vehicle control device of claim 18, wherein the preset condition includes a first condition, which is set to determine a magnitude of a braking force based on the brake information, a second condition, which is set to determine whether the vehicle is slipping based on the wheel speed information, and a third condition, which is set to determine a slope of a road based on the gradient information.

20. The vehicle control device of claim 17, wherein the distinction algorithm is an algorithm that converts speed information, acceleration information and the driving force into matrix format, and determines one or more identification information using one or more matrix operations.
